(19) United States
(12) Patent Application Publication
(10) Pub. No.: US 2024/0067110 A1
(43) Pub. Date: Feb. 29, 2024

(54) POWER MANAGEMENT INTEGRATED CIRCUIT (PMIC) POWER SUPPLY MONITORING WITHOUT EXTERNAL MONITORING CIRCUITRY

(71) Applicant: QUALCOMM Incorporated, San Diego, CA (US)

(72) Inventors: Amit ANEJA, Chandler, AZ (US); Vasant Kumar EASWARAN, Frisco, TX (US); Rahul GULATI, San Diego, CA (US)

(21) Appl. No.: 18/457,066

(22) Filed: Aug. 28, 2023

Related U.S. Application Data
(60) Provisional application No. 63/374,043, filed on Aug. 31, 2022.

(51) Int. Cl. B60R 16/03; B60R 16/023

(52) U.S. Cl. CPC B60R 16/03; B60R 16/0232

(57) ABSTRACT

Techniques and apparatus for power supply monitoring in in-vehicle systems, such as advanced driver assistance systems (ADASs), in-vehicle infotainment (IVI) systems, and/or automated driving (AD) systems. One example method of power supply monitoring generally includes regulating power to a main domain of a system on a chip (SoC) using at least one main domain (MD) power management integrated circuit (PMIC); regulating power to a safety domain of the SoC using at least one safety domain (SD) PMIC; powering the at least one SD PMIC using a SD PMIC power supply rail; and monitoring the SD PMIC power supply rail using the at least one MD PMIC. For certain aspects, the method further includes powering the at least one MD PMIC using a MD PMIC power supply rail and monitoring the MD PMIC power supply rail using the at least one SD PMIC.

### CROSS-REFERENCE TO RELATED APPLICATION(S)

This application claims the benefit of and priority to U.S. Provisional Application No. 63/374,043, entitled “Power Management Integrated Circuit (PMIC) Power Supply Monitoring without External Monitoring Circuitry” and filed Aug. 31, 2022, which is expressly incorporated by reference herein in its entirety as if fully set forth below and for all applicable purposes.

### FIELD OF THE DISCLOSURE

Certain aspects of the present disclosure generally relate to electronic components, and more particularly to power management integrated circuit (PMIC) power supply monitoring in in-vehicle systems.

### BACKGROUND

A voltage regulator ideally provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A linear regulator may be implemented by a low-dropout (LDO) regulator, for example. A switching regulator may be implemented by a switched-mode power supply (SMPS), such as a buck converter, a boost converter, a buck-boost converter, or a charge pump.

Power management integrated circuits (PMICs) are used for managing the power demand of a host system and may include and/or control one or more voltage regulators (e.g., LDOs and/or SMPSs). A PMIC may be used in devices, such as vehicles, to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure generally relate to techniques and apparatus for power supply monitoring in systems with multiple independent domains, such as in-vehicle systems with a main domain and a safety domain.

Certain aspects of the present disclosure provide an apparatus for vehicle operation. The apparatus generally includes a system on a chip (SoC) comprising a main domain and a safety domain; at least one main domain (MD) power management integrated circuit (PMIC); at least one MD power supply rail coupled between the at least one MD PMIC and the main domain of the SoC for supplying power to the main domain of the SoC; at least one safety domain (SD) PMIC; at least one SD power supply rail coupled between the at least one SD PMIC and the safety domain of the SoC for supplying power to the safety domain of the SoC; a MD PMIC power supply rail coupled to the at least one MD PMIC for supplying power to the at least one MD PMIC; and a SD PMIC power supply rail coupled to the at least one SD PMIC for supplying power to the at least one SD PMIC. The at least one MD PMIC has an input coupled to the SD PMIC power supply rail for monitoring the SD PMIC power supply rail.

Certain aspects of the present disclosure provide an apparatus for vehicle operation. The apparatus generally includes a SoC comprising a main domain and a safety domain; at least one MD PMIC; at least one MD power supply rail coupled between the at least one MD PMIC and the main domain of the SoC for supplying power to the main domain of the SoC; at least one SD PMIC; at least one SD power supply rail coupled between the at least one SD PMIC and the safety domain of the SoC for supplying power to the safety domain of the SoC; a MD PMIC power supply rail coupled to the at least one MD PMIC for supplying power to the at least one MD PMIC; and a SD PMIC power supply rail coupled to the at least one SD PMIC for supplying power to the at least one SD PMIC, wherein the at least one SD PMIC has an input coupled to the MD PMIC power supply rail for monitoring the MD PMIC power supply rail.

Certain aspects of the present disclosure provide a method of power supply monitoring. The method generally includes regulating power to a main domain of a SoC using at least one MD PMIC, regulating power to a safety domain of the SoC using at least one SD PMIC, powering the at least one SD PMIC using a SD PMIC power supply rail, and monitoring the SD PMIC power supply rail using the at least one MD PMIC.

Certain aspects of the present disclosure provide a method of power supply monitoring. The method generally includes regulating power to a main domain of a SoC using at least one MD PMIC, regulating power to a safety domain of the SoC using at least one SD PMIC, powering the at least one MD PMIC using a MD PMIC power supply rail, and monitoring the MD PMIC power supply rail using the at least one SD PMIC.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a block diagram of an example vehicle with an in-vehicle system, in which aspects of the present disclosure may be practiced.

FIG. 2 is a block diagram of an example in-vehicle system with main and safety domain PMIC power supply rail monitoring performed by external monitoring circuitry.

FIG. 3 is a block diagram of an example in-vehicle system with main and safety domain PMIC power supply rail monitoring performed by a safety domain PMIC and one or more main domain PMICs, respectively, in accordance with certain aspects of the present disclosure.

FIGS. 4 and 5 are flow diagrams depicting example operations for power supply monitoring, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure generally relate to power management integrated circuit (PMIC) power supply monitoring in in-vehicle systems, such as advanced driver assistance systems (ADASs), in-vehicle infotainment (IVI) systems, and/or automated driving (AD) systems, without using external monitoring circuitry. One example method generally includes regulating power to a main domain of a system on a chip (SoC) using at least one main domain (MD) PMIC, regulating power to a safety domain of the SoC using at least one safety domain (SD) PMIC, powering the at least one SD PMIC using a SD PMIC power supply rail, and monitoring the SD PMIC power supply rail using the at least one MD PMIC. For certain aspects, the method further includes powering the at least one MD PMIC using a MD PMIC power supply rail and monitoring the MD PMIC power supply rail using the at least one SD PMIC. As used herein, “external monitoring circuitry” generally refers to circuitry outside a module or other unit containing the SoC, MD PMIC(s), and/or SD PMIC(s). For certain aspects, however, the external monitoring circuitry may be disposed on the same printed circuit board (PCB) as other components described herein, including the SoC, MD PMIC(s), and/or SD PMIC(s).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### Example Vehicle and In-Vehicle Systems

Modern vehicles come with multiple features for safety, navigation, entertainment, etc., such as ADASs and IVI. Modern vehicles are able to sense and/or communicate with other vehicles and/or objects on the road, which allows for improvement in predictive safety features and AD. IVI is no longer just for entertainment purposes and may ideally work hand-in-hand with safety features, including an ADAS, especially in modern vehicles equipped with AD capabilities. As the automotive industry is transitioning to AD vehicles, ADASs are merging with IVI. Merging ADAS and IVI will improve drive safety and improve the overall driving experience. Stated differently, as the driving experience becomes autonomous, there is an increased demand for both passenger safety and entertainment.

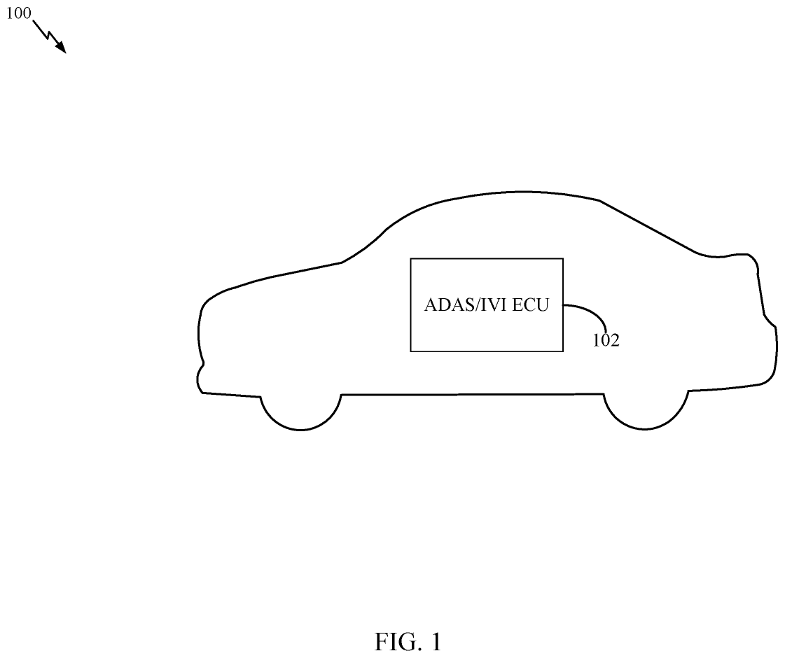

FIG. 1 is a block diagram of an example vehicle 100 with an in-vehicle system, in which aspects of the present disclosure may be practiced. For example, the vehicle 100 may include an in-vehicle ADAS/IVI electrical control unit (ECU) 102. Merged ADAS/IVI ECUs may include at least one SoC having a MD and a SD. In some aspects, the in-vehicle ADAS/IVI ECU 102 may be coupled to at least one external ECU (not shown in FIG. 1).

### Example PMIC Power Supply Monitoring Using External Monitoring Circuitry

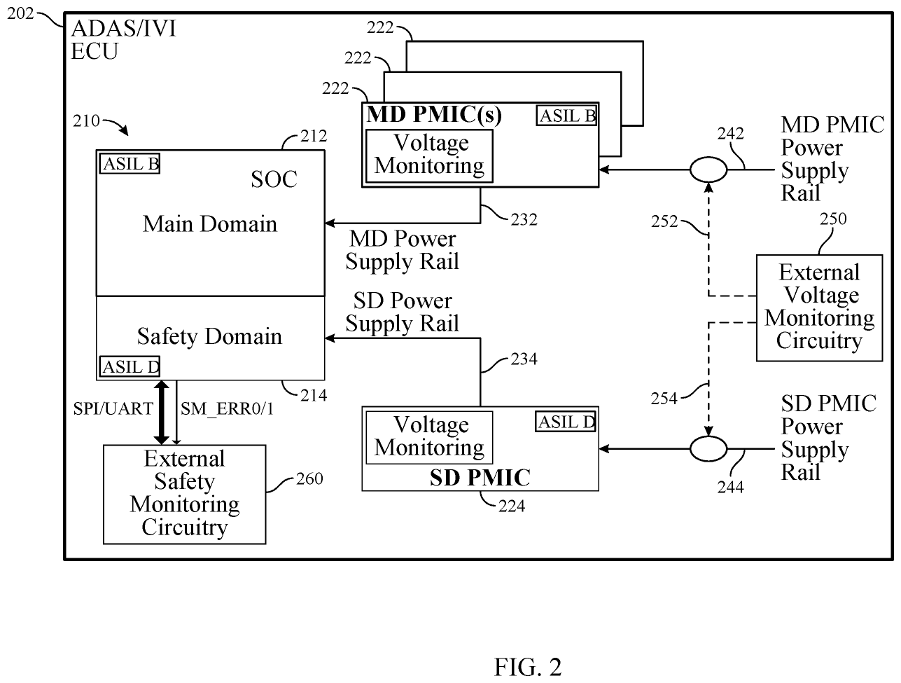

FIG. 2 is a block diagram of an example ADAS/IVI ECU 202 with main and safety domain PMIC power supply rail monitoring performed by external monitoring circuitry. The ADAS/IVI ECU 202 may include a SoC 210 having at least two independent domains: at least one main domain (MD) 212 and at least one safety domain (SD) 214, the latter also being referred to as a “safety island” or “SAIL.” For ease of description and illustration, the remainder of the disclosure may refer to a MD 212 and an SD 214, but the reader is to understand that there may be more than one MD and/or more than one SD.

In certain aspects, according to the ISO 26262 automotive standard, for example, the MD 212 and one or more MD PMIC(s) 222 meet the integrity requirements of up to automotive safety integrity level (ASIL) B. The SD 214 and one or more SD PMIC(s) 224 may meet the integrity level of up to ASIL D. Stated differently, the SD 214 is typically configured to support a more stringent safety standard than the MD 212.

The MD 212 may be coupled to and receive power from at least one MD PMIC 222 via a MD power supply rail 232. A MD PMIC power supply rail 242 from a MD external voltage source (not shown) may be coupled to the MD PMIC(s) 222 and used to supply power to the MD PMIC(s) 222.

The SD 214 may be coupled to and receive power from at least one SD PMIC 224 via a SD power supply rail 234. An SD PMIC power supply rail 244 from an external SD voltage source (not shown) may be coupled to the SD PMIC(s) 224 and used to supply power to the SD PMIC(s) 224. In this manner, the MD 212 and the SD 214 are independent from a voltage-domain standpoint, meaning the MD 212 and the SD 214 are powered from separate voltage rails supplied by independent PMICs (the MD PMIC(s) 222 and the SD PMIC(s) 224, respectively).

In order to ensure safe operation of a vehicle (e.g., vehicle 100), it may be desirable to monitor the PMIC power supply rails provided by both external power sources (e.g., the MD PMIC power supply rail 242 and the SD PMIC power supply rail 244) to detect a fault that can impact the PMIC(s) (e.g., the MD PMIC(s) 222 and/or the SD PMIC(s) 224) and in turn the SoC 210, since the SoC 210 may be performing safety-critical applications. Therefore, external voltage monitoring circuitry 250 may be coupled to both PMIC power supply rails provided by each respective external power source (e.g., the MD PMIC power supply rail 242 and the SD PMIC power supply rail 244). In some cases, the external voltage monitoring circuitry 250 may be circuitry outside the printed circuit board (PCB) supporting or the ECU containing the SoC 210, MD PMIC(s) 222, and/or SD PMIC(s) 224. In other cases, the external voltage monitoring circuitry 250 may be circuitry that resides on the same PCB as or in the ECU with the SoC 210, MD PMIC(s) 222, and/or SD PMIC(s) 224, as illustrated in FIG. 2.

The external voltage monitoring circuitry 250 may be a system-level supervisor, for example, which may be implemented by a microcontroller. A first input 252 of the external voltage monitoring circuitry 250 may be coupled to the MD PMIC power supply rail 242, and a second input 254 of the external voltage monitoring circuitry 250 may be coupled to the SD PMIC power supply rail 244, as illustrated in FIG. 2. The external voltage monitoring circuitry 250 may be used to detect a fault in the MD PMIC power supply rail 242 provided to the MD PMIC(s) 222 and/or a fault in the SD PMIC power supply rail 244 provided to the SD PMIC(s) 224. The external voltage monitoring circuitry 250 may provide a state of the MD PMIC power supply rail 242 and/or the SD PMIC power supply rail 244 to external safety monitoring circuitry 260. In some cases, the external safety monitoring circuitry 260 may be circuitry outside the PCB supporting or the ECU containing the SoC 210, MD PMIC(s) 222, and/or SD PMIC(s) 224. In such cases, the external safety monitoring circuitry 260 may be implemented as a microcontroller or an external ECU, which may be coupled to the in-vehicle ADAS/IVI ECU 202. In other cases, the external safety monitoring circuitry 260 may be circuitry that resides on the same PCB as or in the same ECU with one or more of the SoC 210, MD PMIC(s) 222, and SD PMIC(s) 224, as illustrated in FIG. 2. The external voltage monitoring circuitry 250 may provide the state of the MD PMIC power supply rail 242 and/or the SD PMIC power supply rail 244 continuously, periodically, intermittently, or in response to a query, for example.

However, adding the external voltage monitoring circuitry 250 increases the bill of materials (BOM) cost and adds additional dependencies, thus adding additional design complexities on system integrators (e.g., automotive original equipment manufacturers (OEMs)).

### Example PMIC Power Supply Monitoring without Using External Monitoring Circuitry

To reduce the BOM cost and complexity of design for PMIC rail monitoring, certain aspects of the present disclosure use a PMIC in one domain to monitor the voltage of the PMIC power supply rail in another domain. For example, the SD PMIC power supply rail 244 may be monitored by the MD PMIC(s) 222, and the MD PMIC power supply rail 242 may be monitored by the SD PMIC(s) 224, such that the external voltage monitoring circuitry 250 may be eliminated.

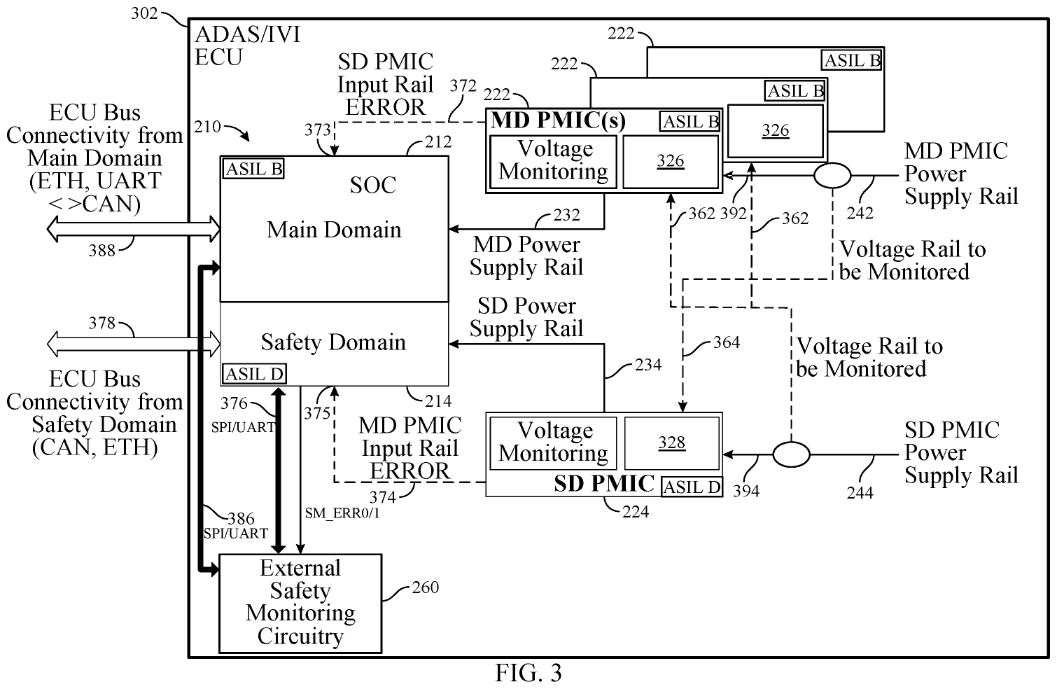

FIG. 3 is a block diagram of an example ADAS/IVI ECU 302 with main and safety domain PMIC power supply rail monitoring performed by the SD PMIC(s) 224 and the MD PMIC(s) 222, respectively, in accordance with certain aspects of the present disclosure. The ADAS/IVI ECU 302 of FIG. 3 may be similar to the ADAS/IVI ECU 202 of FIG. 2, except that the external voltage monitoring circuitry 250 is absent and the PMICs may have additional inputs for power supply rail sensing. The ADAS/IVI ECU 302 may be implemented as a module that includes the SoC 210, the MD PMIC(s) 222, and the SD PMIC(s) 224.

In the ADAS/IVI ECU 302, at least one MD PMIC 222 may have an input 362 coupled to the SD PMIC power supply rail 244 supplied by the external SD voltage source (not shown). Additionally or alternatively, the at least one SD PMIC 224 may have an input 364 coupled to the MD PMIC power supply rail 242 supplied by the external MD voltage source (not shown). The SD PMIC power supply rail 244 may be coupled to a sensing input 326 (e.g., an analog-to-digital converter (ADC) channel, remote sense pins, or another circuit configured to measure the voltage of the power supply rail 244) of one or more of the MD PMICs 222. The MD PMIC power supply rail 242 may be coupled to a sensing input 328 (e.g., an ADC channel, remote sense pins, or another circuit configured to measure the voltage of the power supply rail 242) of one or more of the SD PMICs 224. Advantageously, the MD PMIC(s) 222 may monitor the SD PMIC power supply rail 244, and the SD PMIC(s) 224 may monitor the MD PMIC power supply rail 242, such that the external voltage monitoring circuitry 250 may be eliminated. Power supply rail monitoring may include sensing a voltage and/or a current of a power supply rail.

The MD PMIC(s) 222 may have an output 372 coupled to an input 373 of the MD 212 and may be used to indicate to the MD 212 a state of the SD PMIC power supply rail 244. For example, the MD PMIC 222 may report to the MD 212 whether the SD PMIC power supply rail 244 has a voltage outside an acceptable voltage range or below a threshold voltage value and is experiencing a fault. The SD PMIC 224 may have an output 374 coupled to an input 375 of the SD 214 and may be used to indicate to the SD 214 whether the MD PMIC power supply rail 242 has a voltage outside an acceptable voltage range or below a threshold voltage value and is experiencing a fault.

With the architecture described above, several different strategies exist for monitoring the MD PMIC power supply rail 242 and/or the SD PMIC power supply rail 244. For example, at a first level, a PMIC itself (e.g., one or more of the MD PMIC(s) 222 and/or the SD PMIC(s) 224) may detect input voltage violations (e.g., of ±5%) from an expected or configured PMIC input voltage value (e.g., at input 392 coupled to the MD PMIC power supply rail 242 and/or input 394 coupled to the SD PMIC power supply rail 244).

At a second level, when the SD PMIC(s) 224 determine that the MD PMIC power supply rail 242 is in a fault state, the SD PMIC(s) 224 may inform the SD 214 of the SoC 210 that the MD PMIC 222 is experiencing an error (e.g., a functional safety (FuSa) error). Additionally, the SD 214 may inform (a safety domain of) the external safety monitoring circuitry 260 (e.g., a microcontroller unit (MCU)), over a suitable interface 376, such as a serial peripheral interface (SPI) or a universal asynchronous transceiver (UART) interface, of the fault on the MD PMIC power supply rail 242. Alternatively, the SD PMIC(s) 224 may inform (a safety domain of) the external safety monitoring circuitry 260 over a suitable interface (not shown, but coupled between the SD PMIC(s) 224 and circuitry 260) of the fault on the MD PMIC power supply rail 242. In addition or as an alternative to informing the SD 214 and/or the external safety monitoring circuitry 260, the SD 214 (or the SD PMIC 224) may inform an external ECU (e.g., a safety domain of the external ECU) over a suitable connection, such as a bus 378 (e.g., a controller area network (CAN) or Ethernet (ETH) bus), of the fault on the MD PMIC power supply rail 242.

When the MD PMIC(s) 222 determine that the SD PMIC power supply rail 244 is in a fault state, the MD PMIC(s) 222 may inform safety monitor software running on the MD 212 that the SD PMIC power supply rail 244 is experiencing an error (e.g., a FuSa error). The safety monitor software may then further inform the external safety monitoring circuitry 260 over a suitable interface 386, such as a SPI or a UART interface, of the error on the SD PMIC power supply rail 244. Additionally or alternatively, the safety monitor software may inform one or more other ECUs about the fault via a connected interface, such as a bus 388 (e.g., an Ethernet, UART, or a CAN bus), about the error.

In the case of a common-cause fault, for example, it is possible that the power supply voltage to both the MD PMIC(s) 222 and the SD PMIC(s) 224 could be equally impacted temporally and in terms of failure mode, such that the previously described methods may not work correctly. This scenario could be assumed as a residual fault, for example, in the system integrator's (e.g., Automotive OEM or Tier 1) system safety concept. Alternatively, the system integrator may implement separation of power supply rail sources to the MD PMIC(s) 222 and to the SD PMIC(s) 224 to minimize such a residual fault associated with the previously described method. In other words, the external power supplies to the MD PMIC(s) 222 and the SD PMIC(s) 224 may be implemented as separate and independent supplies, such that the two power supplies are less likely to both be impacted when an issue occurs.

With the architecture described above, several different strategies exist for PMIC rail monitoring. In one example, the PMICs 222, 224 may monitor the PMIC power supply rail voltages through their respective sensing inputs 326, 328 (e.g., ADC channels, remote sensing pins, or other circuits configured to measure the voltage level of the power supply rail voltages). For example, the MD PMIC(s) 222 may determine the SD PMIC power supply rail voltage through one or more of their respective ADCs. An internal MD PMIC controller or other logic of each of these MD PMIC(s) 222 may read the voltage values of the SD PMIC power supply rail 244 and store indications of these values in memory, such as a local MD PMIC random access memory (RAM). This local RAM may be read by safety monitor software running on the MD 212 of the SoC 210, for example, over a system power management interface (SPMI) bus. For certain aspects, the values stored in the local RAM may be read out at some defined periodic cadence (e.g., every 5 ms), continuously, or intermittently (e.g., as requested). Similarly, the SD PMIC(s) 224 may determine the MD PMIC power supply rail voltage through one or more of their respective ADCs. An internal SD PMIC controller or other logic of each of these SD PMIC(s) may read the voltage values of the MD PMIC power supply rail 242 and store indications of these values in memory, such as a local SD PMIC RAM. This local SD PMIC RAM may be read by software running on the SD, for example, over an inter-integrated circuit (I²C) bus. For certain aspects, the values stored in the local SD PMIC RAM may be read out at some defined periodic cadence (e.g., every 5 ms) or with some other timing. The same operations may also be performed by the remote sense pins of the PMICs if the ADCs are not available (or vice versa).

In certain aspects, a PMIC itself may (continuously) check the ADC input against one or more thresholds and send an error indication to the MD 212 or SD 214 of the SoC 210 if a violation is detected. When the external signals are going through voltage monitors, the PMIC (e.g., one or more of the MD PMIC(s) 222 and/or the SD PMIC(s) 224) can generate a fault (e.g., a WARNING/Level 1 or ERROR/Level 2) when the programmed threshold(s) are exceeded.

According to certain aspects, the SoC 210 may include two or more SDs 214. For example, the two or more SDs 214 may include a first SD configured to meet the integrity level of up to ASIL C and a second SD configured to meet the integrity level up to ASIL D. The two or more SDs 214 may be coupled to and receive power from the same SD PMIC 224, or from separate SD PMICs 224. The rails of the SD PMIC(s) (e.g., SD PMIC power supply rail(s) 244) may be monitored without external voltage monitoring circuitry, as described herein.

### Example Power Supply Operations

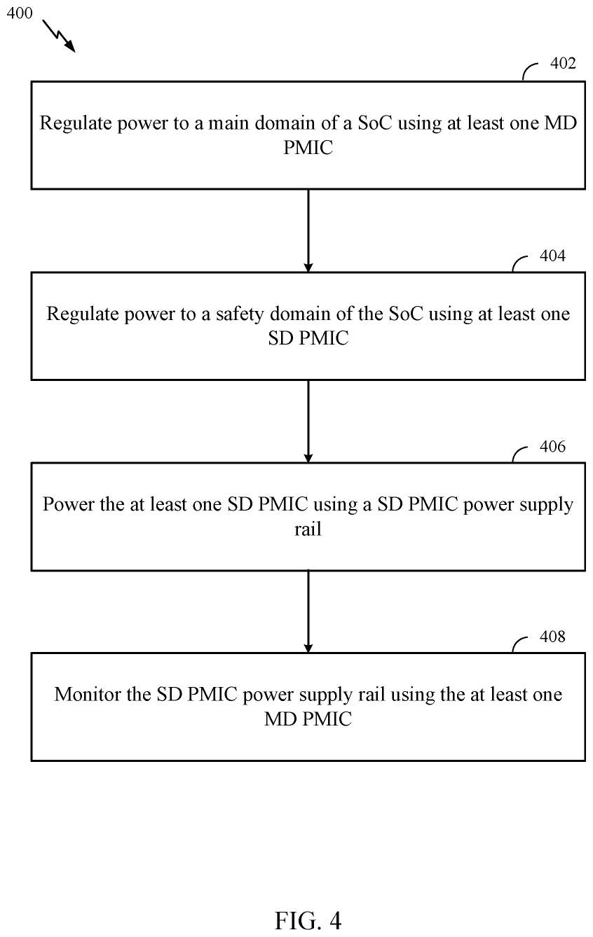

FIG. 4 is a flow diagram depicting example operations 400 for power supply monitoring, in accordance with certain aspects of the present disclosure. The operations 400 may be performed by a circuit (e.g., the ADAS/IVI ECU 302 of FIG. 3).

The operations 400 may begin, at block 402, with at least one main domain (MD) power management integrated circuit (PMIC) (e.g., MD PMIC(s) 222) regulating power to at least one main domain (e.g., MD 212) of a system on a chip (SoC) (e.g., SoC 210). At block 404, at least one safety domain (SD) PMIC (e.g., SD PMIC(s) 224) may regulate power to at least one safety domain (e.g., SD 214) of the SoC. A SD PMIC power supply rail (e.g., SD PMIC power supply rail 244) may power the at least one SD PMIC at block 406. At block 408, the at least one MD PMIC may monitor the SD PMIC power supply rail.

According to certain aspects, the operations 400 further include sending an indication of a state of the SD PMIC power supply rail from the at least one MD PMIC to the at least one main domain of the SoC.

According to certain aspects, the operations 400 further include sending an indication of a state of the SD PMIC power supply rail from the at least one MD PMIC to a control unit external to a module (e.g., the ADAS/IVI ECU 302) that includes the SoC (e.g., via a Ethernet, UART, or CAN bus, such as bus 388).

According to certain aspects, the operations 400 further include powering the at least one MD PMIC using a MD PMIC power supply rail (e.g., MD PMIC power supply rail 242), and monitoring the MD PMIC power supply rail using the at least one SD PMIC. The operations 400 may further include sending an indication of a state of the MD PMIC power supply rail from the at least one SD PMIC to the at least one safety domain of the SoC. In certain aspects, the operations 400 may also include sending an indication of a state of the MD PMIC power supply rail from the at least one SD PMIC to a control unit (e.g., via a CAN or Ethernet bus, such as bus 378) or to a safety monitor (e.g., external safety monitoring circuitry 260), external to a module (e.g., the ADAS/IVI ECU 302) that includes the SoC.

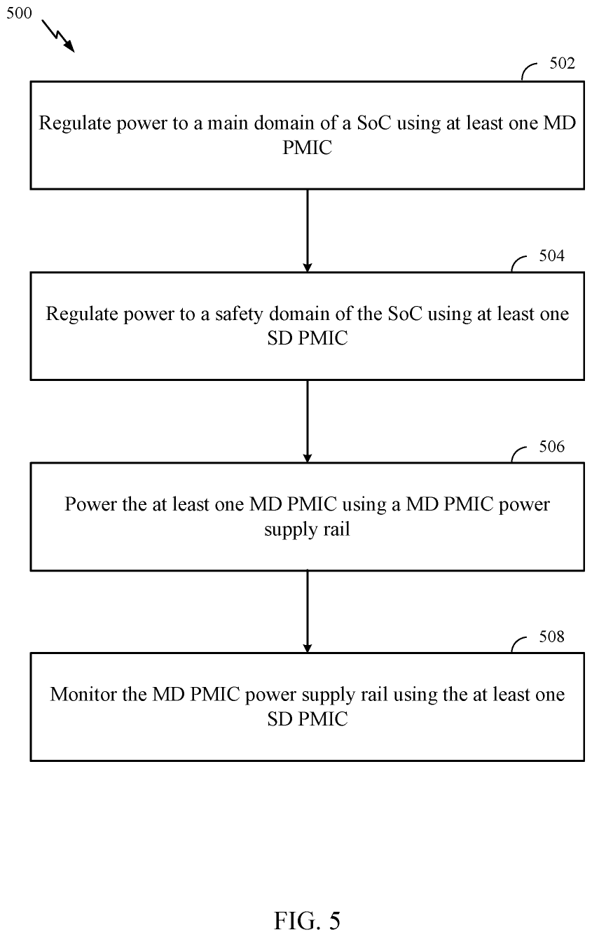

FIG. 5 is a flow diagram portraying example operations 500 for power supply monitoring, in accordance with certain aspects of the present disclosure. The operations 500 may be performed by a circuit (e.g., the ADAS/IVI ECU 302 of FIG. 3).

The operations 500 may begin, at block 502, with at least one MD PMIC (e.g., MD PMIC(s) 222) regulating power to a main domain (e.g., MD 212) of a SoC (e.g., SoC 210). At block 504, at least one SD PMIC (e.g., the SD PMIC(s) 224) may regulate power to at least one safety domain (e.g., SD 214, also referred to as a “safety island” or “SAIL” domain) of the SoC. A MD PMIC power supply rail (e.g., MD PMIC power supply rail 242) may power the at least one MD PMIC at block 506. At block 508, the at least one SD PMIC may monitor the MD PMIC power supply rail.

According to certain aspects, the operations 500 further include sending an indication of a state of the MD PMIC power supply rail from the at least one SD PMIC to the at least one safety domain of the SoC.

According to certain aspects, the operations 500 further include sending an indication of a state of the MD PMIC power supply rail from the at least one SD PMIC to a control unit (e.g., via a CAN or Ethernet bus, such as bus 378) or to a safety monitor (e.g., external safety monitoring circuitry 260), external to a module that includes the SoC.

### Example Aspects

Implementation examples are described in the following numbered aspects:

Aspect 1: An apparatus for vehicle operation, comprising: a system on a chip (SoC) comprising a main domain and a safety domain; at least one main domain (MD) power management integrated circuit (PMIC); at least one MD power supply rail coupled between the at least one MD PMIC and the main domain of the SoC for supplying power to the main domain of the SoC; at least one safety domain (SD) PMIC; at least one SD power supply rail coupled between the at least one SD PMIC and the safety domain of the SoC for supplying power to the safety domain of the SoC; a MD PMIC power supply rail coupled to the at least one MD PMIC for supplying power to the at least one MD PMIC; and a SD PMIC power supply rail coupled to the at least one SD PMIC for supplying power to the at least one SD PMIC, wherein the at least one MD PMIC has an input coupled to the SD PMIC power supply rail for monitoring the SD PMIC power supply rail.

Aspect 2: The apparatus of Aspect 1, wherein the at least one MD PMIC has an output coupled to an input of the main domain of the SoC for indicating a state of the SD PMIC power supply rail.

Aspect 3: The apparatus of Aspect 1 or 2, wherein the at least one MD PMIC has an output for coupling to an input of a control unit external to the apparatus for indicating a state of the SD PMIC power supply rail.

Aspect 4: The apparatus of any of the preceding Aspects, wherein the input of the at least one MD PMIC is coupled to an analog-to-digital converter (ADC) channel or remote sense pins of the at least one MD PMIC.

Aspect 5: The apparatus of any of the preceding Aspects, wherein the at least one SD PMIC has an input coupled to the MD PMIC power supply rail for monitoring the MD PMIC power supply rail.

Aspect 6: The apparatus of any of the preceding Aspects, wherein the at least one SD PMIC has an output coupled to an input of the safety domain of the SoC for indicating a state of the MD PMIC power supply rail.

Aspect 7: The apparatus of Aspect 5 or 6, wherein the input of the at least one SD PMIC is coupled to an analog-to-digital converter (ADC) channel or remote sense pins of the at least one SD PMIC.

Aspect 8: The apparatus of any of Aspects 5 to 7, wherein the at least one SD PMIC has an output for coupling to an input of a control unit or of a safety monitor, external to the apparatus for indicating a state of the MD PMIC power supply rail.

Aspect 9: The apparatus of any of the preceding Aspects, wherein the safety domain of the SoC is independent from the main domain of the SoC.

Aspect 10: The apparatus of any of the preceding Aspects, wherein the safety domain of the SoC is configured to support a more stringent safety standard than the main domain of the SoC.

Aspect 11: The apparatus of any of the preceding Aspects, wherein the safety domain of the SoC is configured to comply with up to Automotive Safety Integrity Level (ASIL) D requirements and wherein the main domain of the SoC is configured to comply with up to ASIL B requirements.

Aspect 12: The apparatus of any of the preceding Aspects, wherein the at least one SD PMIC is configured to comply with up to the ASIL D requirements and wherein the at least one MD PMIC is configured to comply with up to the ASIL B requirements.

Aspect 13: An apparatus for operating a vehicle, comprising: a system on a chip (SoC) comprising a main domain and a safety domain; at least one main domain (MD) power management integrated circuit (PMIC); at least one MD power supply rail coupled between the at least one MD PMIC and the main domain of the SoC for supplying power to the main domain of the SoC; at least one safety domain (SD) PMIC; at least one SD power supply rail coupled between the at least one SD PMIC and the safety domain of the SoC for supplying power to the safety domain of the SoC; a MD PMIC power supply rail coupled to the at least one MD PMIC for supplying power to the at least one MD PMIC; and a SD PMIC power supply rail coupled to the at least one SD PMIC for supplying power to the at least one SD PMIC, wherein the at least one SD PMIC has an input coupled to the MD PMIC power supply rail for monitoring the MD PMIC power supply rail.

Aspect 14: The apparatus of Aspect 13, wherein the at least one SD PMIC has an output coupled to an input of the safety domain of the SoC for indicating a state of the MD PMIC power supply rail.

Aspect 15: The apparatus of Aspect 13 or 14, wherein the input of the at least one SD PMIC is coupled to an analog-to-digital converter (ADC) channel or remote sense pins of the at least one SD PMIC.

Aspect 16: The apparatus of any of Aspects 13 to 15, wherein the at least one SD PMIC has an output for coupling to an input of a control unit or of a safety monitor, external to the apparatus for indicating a state of the MD PMIC power supply rail.

Aspect 17: The apparatus of any of Aspects 13 to 16, wherein the safety domain of the SoC is independent from the main domain of the SoC.

Aspect 18: The apparatus of any of Aspects 13 to 17, wherein the safety domain of the SoC is configured to support a more stringent safety standard than the main domain of the SoC.

Aspect 19: The apparatus of any of Aspects 13 to 18, wherein the safety domain of the SoC is configured to comply with up to Automotive Safety Integrity Level (ASIL) D requirements and wherein the main domain of the SoC is configured to comply with up to ASIL B requirements.

Aspect 20: The apparatus of any of Aspects 13 to 19, wherein the at least one SD PMIC is configured to comply with up to the ASIL D requirements and wherein the at least one MD PMIC is configured to comply with up to the ASIL B requirements.

Aspect 21: A method of power supply monitoring, comprising: regulating power to a main domain of a system on a chip (SoC) using at least one main domain (MD) power management integrated circuit (PMIC); regulating power to a safety domain of the SoC using at least one safety domain (SD) PMIC; powering the at least one SD PMIC using a SD PMIC power supply rail; and monitoring the SD PMIC power supply rail using the at least one MD PMIC.

Aspect 22: The method of Aspect 21, further comprising sending an indication of a state of the SD PMIC power supply rail from the at least one MD PMIC to the main domain of the SoC.

Aspect 23: The method of Aspect 21 or 22, further comprising sending an indication of a state of the SD PMIC power supply rail from the at least one MD PMIC to a control unit external to a module that includes the SoC.

Aspect 24: The method of any of Aspects 21 to 23, further comprising: powering the at least one MD PMIC using a MD PMIC power supply rail; and monitoring the MD PMIC power supply rail using the at least one SD PMIC.

Aspect 25: The method of Aspect 24, further comprising sending an indication of a state of the MD PMIC power supply rail from the at least one SD PMIC to the safety domain of the SoC.

Aspect 26: The method of Aspect 24 or 25, further comprising sending an indication of a state of the MD PMIC power supply rail from the at least one SD PMIC to a control unit or to a safety monitor, external to a module that includes the SoC.

Aspect 27: A method of power supply monitoring, comprising: regulating power to a main domain of a system on a chip (SoC) using at least one main domain (MD) power management integrated circuit (PMIC); regulating power to a safety domain of the SoC using at least one safety domain (SD) PMIC; powering the at least one MD PMIC using a MD PMIC power supply rail; and monitoring the MD PMIC power supply rail using the at least one SD PMIC.

Aspect 28: The method of Aspect 27, further comprising sending an indication of a state of the MD PMIC power supply rail from the at least one SD PMIC to the safety domain of the SoC.

Aspect 29: The method of Aspect 27 or 28, further comprising sending an indication of a state of the MD PMIC power supply rail from the at least one SD PMIC to a control unit or to a safety monitor, external to a module that includes the SoC.

### ADDITIONAL CONSIDERATIONS

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is to be understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes, and variations may be made in the arrangement, operation, and details of the methods and apparatus described above without departing from the scope of the claims.

1. An apparatus for vehicle operation, comprising:
a system on a chip (SoC) comprising a main domain and a safety domain;
at least one main domain (MD) power management integrated circuit (PMIC);
at least one MD power supply rail coupled between the at least one MD PMIC and the main domain of the SoC for supplying power to the main domain of the SoC;
at least one safety domain (SD) PMIC;
at least one SD power supply rail coupled between the at least one SD PMIC and the safety domain of the SoC for supplying power to the safety domain of the SoC;
a MD PMIC power supply rail coupled to the at least one MD PMIC for supplying power to the at least one MD PMIC; and
a SD PMIC power supply rail coupled to the at least one SD PMIC for supplying power to the at least one SD PMIC, wherein the at least one MD PMIC has an input coupled to the SD PMIC power supply rail for monitoring the SD PMIC power supply rail.

2. The apparatus of claim 1, wherein the at least one MD PMIC has an output coupled to an input of the main domain of the SoC for indicating a state of the SD PMIC power supply rail.

3. The apparatus of claim 1, wherein the at least one MD PMIC has an output for coupling to an input of a control unit external to the apparatus for indicating a state of the SD PMIC power supply rail.

4. The apparatus of claim 1, wherein the input of the at least one MD PMIC is coupled to an analog-to-digital converter (ADC) channel or remote sense pins of the at least one MD PMIC.

5. The apparatus of claim 1, wherein the at least one SD PMIC has an input coupled to the MD PMIC power supply rail for monitoring the MD PMIC power supply rail.

6. The apparatus of claim 5, wherein the at least one SD PMIC has an output coupled to an input of the safety domain of the SoC for indicating a state of the MD PMIC power supply rail.

7. The apparatus of claim 5, wherein the input of the at least one SD PMIC is coupled to an analog-to-digital converter (ADC) channel or remote sense pins of the at least one SD PMIC.

8. The apparatus of claim 5, wherein the at least one SD PMIC has an output for coupling to an input of a control unit or of a safety monitor, external to the apparatus for indicating a state of the MD PMIC power supply rail.

9. The apparatus of claim 1, wherein the safety domain of the SoC is independent from the main domain of the SoC.

10. The apparatus of claim 1, wherein the safety domain of the SoC is configured to support a more stringent safety standard than the main domain of the SoC.

11. The apparatus of claim 1, wherein the safety domain of the SoC is configured to comply with up to Automotive Safety Integrity Level (ASIL) D requirements and wherein the main domain of the SoC is configured to comply with up to ASIL B requirements.

12. The apparatus of claim 11, wherein the at least one SD PMIC is configured to comply with up to the ASIL D requirements and wherein the at least one MD PMIC is configured to comply with up to the ASIL B requirements.

13. An apparatus for operating a vehicle, comprising:
a system on a chip (SoC) comprising a main domain and a safety domain;
at least one main domain (MD) power management integrated circuit (PMIC);
at least one MD power supply rail coupled between the at least one MD PMIC and the main domain of the SoC for supplying power to the main domain of the SoC;
at least one safety domain (SD) PMIC;
at least one SD power supply rail coupled between the at least one SD PMIC and the safety domain of the SoC for supplying power to the safety domain of the SoC;
a MD PMIC power supply rail coupled to the at least one MD PMIC for supplying power to the at least one MD PMIC; and
a SD PMIC power supply rail coupled to the at least one SD PMIC for supplying power to the at least one SD PMIC, wherein the at least one SD PMIC has an input coupled to the MD PMIC power supply rail for monitoring the MD PMIC power supply rail.

14. The apparatus of claim 13, wherein the at least one SD PMIC has an output coupled to an input of the safety domain of the SoC for indicating a state of the MD PMIC power supply rail.

15. The apparatus of claim 13, wherein the input of the at least one SD PMIC is coupled to an analog-to-digital converter (ADC) channel or remote sense pins of the at least one SD PMIC.

16. The apparatus of claim 13, wherein the at least one SD PMIC has an output for coupling to an input of a control unit or of a safety monitor, external to the apparatus for indicating a state of the MD PMIC power supply rail.

17. The apparatus of claim 13, wherein the safety domain of the SoC is independent from the main domain of the SoC.

18. The apparatus of claim 13, wherein the safety domain of the SoC is configured to support a more stringent safety standard than the main domain of the SoC.

19. The apparatus of claim 13, wherein the safety domain of the SoC is configured to comply with up to Automotive Safety Integrity Level (ASIL) D requirements and wherein the main domain of the SoC is configured to comply with up to ASIL B requirements.

20. The apparatus of claim 19, wherein the at least one SD PMIC is configured to comply with up to the ASIL D requirements and wherein the at least one MD PMIC is configured to comply with up to the ASIL B requirements.

21. A method of power supply monitoring, comprising:
regulating power to a main domain of a system on a chip (SoC) using at least one main domain (MD) power management integrated circuit (PMIC);
regulating power to a safety domain of the SoC using at least one safety domain (SD) PMIC;
powering the at least one SD PMIC using a SD PMIC power supply rail; and
monitoring the SD PMIC power supply rail using the at least one MD PMIC.

22. The method of claim 21, further comprising sending an indication of a state of the SD PMIC power supply rail from the at least one MD PMIC to the main domain of the SoC.

23. The method of claim 21, further comprising sending an indication of a state of the SD PMIC power supply rail from the at least one MD PMIC to a control unit external to a module that includes the SoC.

24. The method of claim 21, further comprising:
powering the at least one MD PMIC using a MD PMIC power supply rail; and
monitoring the MD PMIC power supply rail using the at least one SD PMIC.

25. The method of claim 24, further comprising sending an indication of a state of the MD PMIC power supply rail from the at least one SD PMIC to the safety domain of the SoC.

26. The method of claim 24, further comprising sending an indication of a state of the MD PMIC power supply rail from the at least one SD PMIC to a control unit or to a safety monitor, external to a module that includes the SoC.

27. A method of power supply monitoring, comprising:
regulating power to a main domain of a system on a chip (SoC) using at least one main domain (MD) power management integrated circuit (PMIC);
regulating power to a safety domain of the SoC using at least one safety domain (SD) PMIC;
powering the at least one MD PMIC using a MD PMIC power supply rail; and
monitoring the MD PMIC power supply rail using the at least one SD PMIC.

28. The method of claim 27, further comprising sending an indication of a state of the MD PMIC power supply rail from the at least one SD PMIC to the safety domain of the SoC.

29. The method of claim 27, further comprising sending an indication of a state of the MD PMIC power supply rail from the at least one SD PMIC to a control unit or to a safety monitor, external to a module that includes the SoC.
